(19) United States
(12) Patent Application Publication
(10) Pub. No.: US 2020/0221745 A1
(43) Pub. Date: Jul. 16, 2020

(54) CAPSULE CONTAINING PURE (ABOUT 100%) STEVIA EXTRACT

(71) Applicant: REELPUR INC., Mercier (CA)

(72) Inventor: FERDINAND TCHOUNKEU, MERCIER (CA)

(21) Appl. No.: 15/755,183

(22) PCT Filed: Oct. 3, 2017
(86) PCT No.: PCT/CA2017/051173

§ 371 Date: Feb. 26, 2018

Related U.S. Application Data
(60) Provisional application No. 62/403,898, filed on Oct. 4, 2016.

(51) Int. Cl. A23L 27/30; A23L 27/00

(52) U.S. Cl. CPC A23L 27/36; A23V 2002/00; A23L 27/72

(57) ABSTRACT

A portioned pure (about 100%) stevia extract. The invention allows for a use of pure (about 100%) stevia extract as tabletop sweetener, i.e., in an amount yielding a sweetness which is comparable to the sweetness of a sugar cube or table spoon.

### FIELD OF THE INVENTION

The present invention relates generally to the presentation and packaging of sweeteners. More specifically, the present invention relates to a capsule containing pure (about 100%) stevia extract. In embodiments of the invention, the content of the capsule has a sweetness which is equivalent to the sweetness a sugar cube or table spoon.

### BACKGROUND OF THE INVENTION

Stevia extract is about 300 (200-400) times sweeter than sucrose or saccharose, the standard sugar commonly used. Typically, a sugar cube or a table spoon (tsp) of sugar weights about 4000-5000 mg (4-5 g). Accordingly, in order to have the same sweetness provided by a sugar cube or a table spoon of sugar, an amount of about 13.5-16.5 mg (in a range of 12.5-25 mg depending of the stevia type and sweetness) of pure stevia extract should be used. Such amount is too small, and thus presents some challenges related to packaging and handling, when it is desired to making available to consumers pure stevia extract for use in a manner similar to the use of sugar cubes or tsp sugar. Making available to consumers a portioned pure stevia extract would need an amount far greater than its sugar equivalent, which would lead to a product that is too sweet, inedible and even unhealthy.

A solution known in the art is to add other ingredients or fillers to the stevia extract, such as to increase the weight of the product, which allows for packaging and handling with relative ease. Such products typically weight 600-3000 mg, which is about 24-240 times the weight of a 100% pure portioned stevia extract (12.5-25 mg). A portioned 100% pure stevia extract of a similar weight, i.e., 600-3000 mg would be inedible and unhealthy for consumers. The fillers and other ingredients are used not only to adjust the taste but mainly to facilitate prepackaging of portioned stevia extract as indicated above. Examples of such products currently found on the market are presented in FIG. 1. And as can be seen in FIG. 2, the product typically includes at least about 2 to 5 additional ingredients in addition to the stevia extract. As a result, the actual stevia extract represents less than about 2 to 5% of the final product. The added ingredients or fillers are generally erythritol, dextrose, maltodextrine, etc.

The inventor is aware of the following documents: U.S. Pat. No. 6,610,337; U.S. 2007-0071808.

There is a need to making available to consumers pure (about 100%) extract of stevia. Also, there is a need to making available to consumers portioned pure (about 100%) stevia extract products.

### SUMMARY OF THE INVENTION

The inventor has designed a presentation and packaging that allows for the use of pure (about 100%) stevia extract as tabletop sweetener. The invention allows for the use of pure (about 100%) stevia extract in an amount yielding a sweetness which is readily comparable to the sweetness of a sugar cube or tablespoon. The product according to the invention, herein also referred to as ReelPur™, is presented in the form of a capsule.

More specifically, the present invention provides the following according to aspects thereof:
(1) A capsule containing a stevia extract.
(2) A capsule containing a stevia extract that is about 100% pure.
(3) A capsule containing a stevia extract that is about 100% pure, wherein the content of the capsule has a sweetness which is equivalent to the sweetness of a sugar cube or table spoon.
(4) A capsule containing a stevia extract that is about 100% pure, wherein the amount of the stevia extract in the capsule is between about 6 to 8 mg, preferably between about 8 to 10 mg, preferably between about 10 to 12 mg, preferably between about 12 to 14 mg, preferably between about 13 to 15 mg, preferably between about 13.5 to 16.5 mg, preferably between about 14 to 17 mg, preferably between about 15 to 19 mg, preferably between about 16 to 20 mg, preferably between about 17 to 21 mg, preferably between about 18 to 22 mg, preferably between about 19 to 23 mg, preferably between about 20 to 24 mg, preferably between about 21 to 25 mg, preferably between about 22 to 26 mg, or preferably between about 6.5 to 8.5 mg, etc.
(5) A capsule containing a stevia extract that is about 100% pure, wherein the amount of the stevia extract in the capsule is between about 13.5 to 16.5 mg.
(6) A capsule containing a stevia extract that is about 100% pure, wherein the amount of the stevia extract in the capsule is between about a multiple of the amount 13.5 to 16.5 mg, for example 27 to 33 mg, 40.5 to 49.5 mg, 54 to 66 mg, etc.
(7) A capsule containing a stevia extract that is about 100% pure, wherein the amount of the stevia extract in the capsule is between about 6.5 to 8.5 mg.
(8) A capsule according to any one of (1) to (7) above, wherein the stevia extract is in a form selected from the group consisting of: powder, liquid, granular, pieces of dry leaf, and combinations thereof.
(9) A capsule according to any one of (1) to (7) above, wherein the stevia extract is in powder form.
(10) A capsule according to any one of (1) to (7) above, further comprising a component selected from the group consisting of nutritional supplement, vitamins, flavours; optionally, the amount of the stevia extract in the capsule is more than about 60% by weight.
(11) A capsule according to any one of (1) to (7) above, wherein the capsule is made of a material selected from the group consisting of: hydroxypropyl methyl cellulose (HPMC) hydroxymethyl cellulose (HMC), gelatin, pullulan naturally fermented from tapioca, vegetable-based material, and combinations thereof.
(12) A capsule according to any one of (1) to (7) above, wherein the capsule is made of a material that is bio-degradable.
(13) A capsule according to any one of (1) to (7) above, wherein the capsule is made of a material that is soluble in aqueous medium.
(14) A capsule according to any one of (1) to (7) above, wherein the capsule is made of a material that is not soluble in aqueous medium.
(15) A capsule according to any one of (1) to (7) above, wherein the capsule is adapted to be operated manually by a user, such as to release the stevia extract.
(16) A capsule according to any one of (1) to (7) above, wherein the capsule has an elongated spherical shape, and has a length between about 7 to 100 mm and a width between about 3 to 28 mm; preferably a length between about 10 to 90 mm and a width between about 4 to 25 mm; preferably a length between about 11.1 to 88.5 mm and a width between about 4.91 to 23.4 mm.
(17) A capsule according to any one of (1) to (7) above, wherein the capsule has an elongated spherical shape, and has a length between about 11.1 to 88.5 mm and a width between about 4.91 to 23.4 mm.
(18) A capsule according to any one of (1) to (7) above, having a size between about 5 to Su07.
(19) A capsule according to any one of (1) to (18) above, wherein the capsule has a color selected from the group consisting of: white, green, brown, colourless, yellow, red, blue, black, ivory, orange, grey, pink, pearly blue, and combinations thereof; optionally the capsule is opaque or transparent.
(20) A capsule according to any one of (1) to (19) above, having a sign printed on an external surface thereof; optionally the sign is selected from the group consisting of: image of a human face, image of an object, group of letters, words, and combinations thereof.
(21) A container comprising a stevia extract.
(22) A container comprising a stevia extract that is about 100% pure.
(23) A portioned stevia extract.
(24) A portioned stevia extract that is about 100% pure.
(25) A method of making available to consumers a stevia extract, the method comprising:
   providing the stevia extract;
   providing a capsule; and
   filling up the capsule with the stevia extract.
(26) A method of making available to consumers a stevia extract that is about 100% pure, the method comprising:
   providing the stevia extract that is about 100% pure;
   providing a capsule; and
   filling up the capsule with the stevia extract that is about 100% pure.
(27) A method of making available to consumers a stevia extract that is about 100% pure, the method comprising:
   providing the stevia extract that is about 100% pure;
   providing a capsule; and
   filling up the capsule with the stevia extract that is about 100% pure,
   wherein the content of the capsule has a sweetness which is equivalent to the sweetness of a sugar cube or table spoon.
(28) A method of making available to consumers a stevia extract that is about 100% pure, the method comprising:
   providing the stevia extract that is about 100% pure;
   providing a capsule; and
   filling up the capsule with the stevia extract that is about 100% pure,
   wherein an amount of the stevia extract is between about 6 to 8 mg, preferably between about 8 to 10 mg, preferably between about 10 to 12 mg, preferably between about 12 to 14 mg, preferably between about 13 to 15 mg, preferably between about 13.5 to 16.5 mg, preferably between about 14 to 17 mg, preferably between about 15 to 19 mg, preferably between about 16 to 20 mg, preferably between about 17 to 21 mg, preferably between about 18 to 22 mg, preferably between about 19 to 23 mg, preferably between about 20 to 24 mg, preferably between about 21 to 25 mg, preferably between about 22 to 26 mg, or preferably between about 6.5 to 8.5 mg, etc.
(29) A method of making available to consumers a stevia extract that is about 100% pure, in an amount yielding a sweetness which is equivalent to the sweetness of a sugar cube or table spoon, the method comprising:
   providing the stevia extract that is about 100% pure;
   providing a capsule; and
   filling up the capsule with the stevia extract that is about 100% pure,
   wherein the amount is between about 13.5 to 16.5 mg.
(30) A method of making available to consumers a stevia extract that is about 100% pure, in an amount yielding a sweetness which is equivalent to the sweetness of half a sugar cube or table spoon, the method comprising:
   providing the stevia extract that is about 100% pure;
   providing a capsule; and
   filling up the capsule with the stevia extract that is about 100% pure,
   wherein the amount is between about 6.5 to 8.5 mg.
(31) A method of using a stevia extract, comprising manually operating a capsule as defined in any one of (1) to (20) above, such as to release the stevia extract for use, for example in a container (cup) containing food (in solid or liquid form).
(32) A package comprising one or more capsules as defined in any one of (1) to (20) above.
(33) A container comprising a plurality of capsules as defined in any one of (1) to (20) above, wherein the container is readily manually operable by a user, such as to release one or more capsules; optionally, the user uses both hands for the operation or a single hand.
(34) A container according to (33) above, which is a capsule distributor.
(35) A kit comprising:
   one or more container as defined in (21) or (22) above; and
   one or more container as defined in (33) or (34) above.
(36) A kit comprising:
   one or more container as defined in (21) or (22) above;
   one or more container as defined in (33) or (34) above; and
   one or more package as defined in (32) above.
(37) A kit according to (35) or (36) above, further comprising a device for retrieving a desired amount of the stevia extract from the one or more container as defined in (21) or (22) above; optionally, the device is a spoon.
(38) A kit according to any one of (35) to (37) above, further comprising instructions for use.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1: Sample of stevia products currently available on the market.

FIG. 2: Sample of stevia products currently available on the market, including ingredients list.

FIG. 3: The stevia extract according to the invention, in powder form and capsules containing same.

FIG. 4: A) Capsule according to the invention containing pure (about 100%) stevia extract. B) Capsule according to the invention in closed form (two capsules on the left) and opened form (one capsule on the right).

FIG. 5: Capsules according to the invention.

FIGS. 6A-6D: Particle size of the product according to the invention in powder form.

FIG. 7: Containers according to the invention.

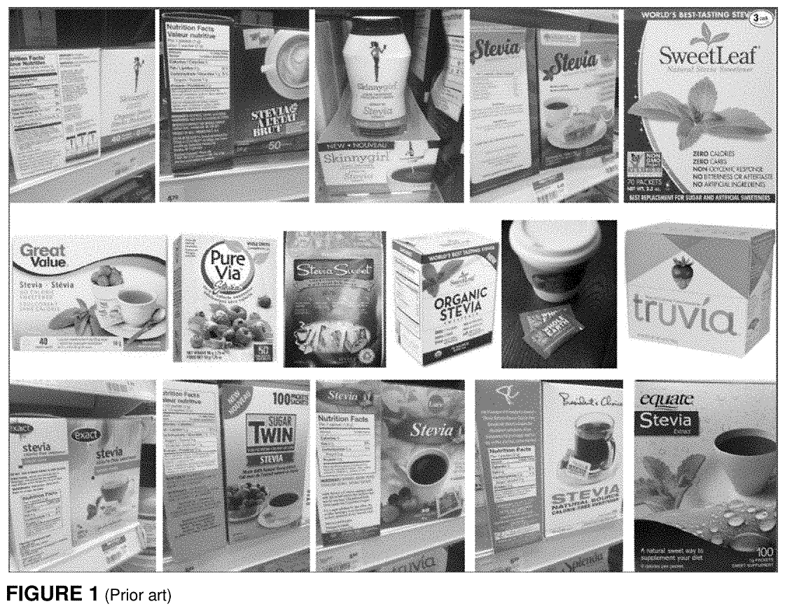

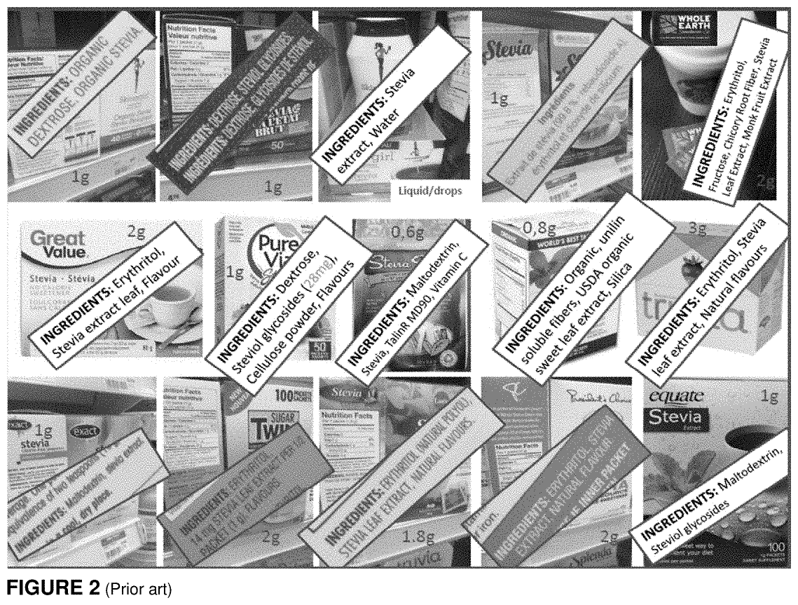

### DESCRIPTION OF ILLUSTRATIVE EMBODIMENTS

The present invention relates to a presentation and packaging that allows for the use of pure (about 100%) stevia extract as tabletop sweetener. The invention allows for the use of pure (about 100%) stevia extract in an amount yielding a sweetness which is readily comparable to the sweetness of a sugar cube or tablespoon. The product according to the invention, herein also referred to as ReelPur™, is presented in the form of a capsule.

The present invention is illustrated in further details by the following non-limiting embodiments.

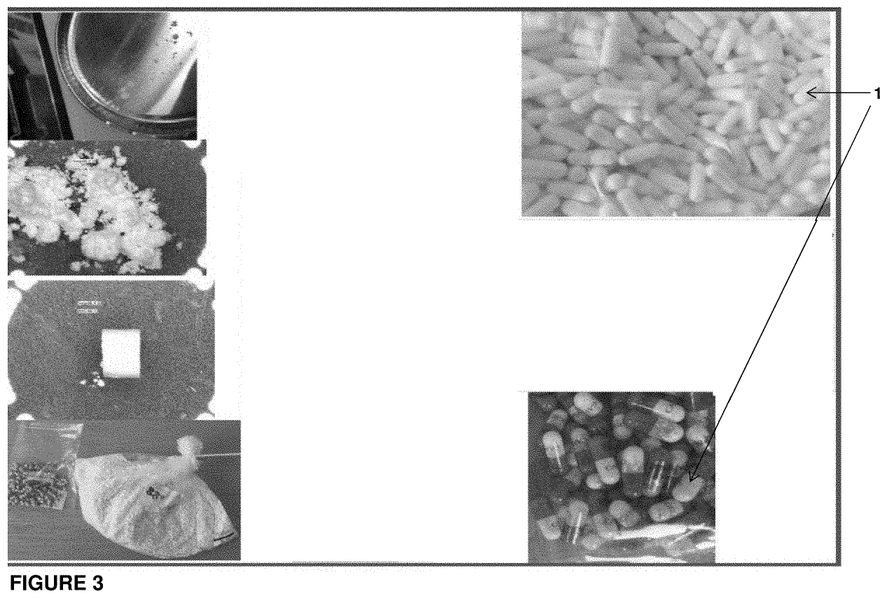

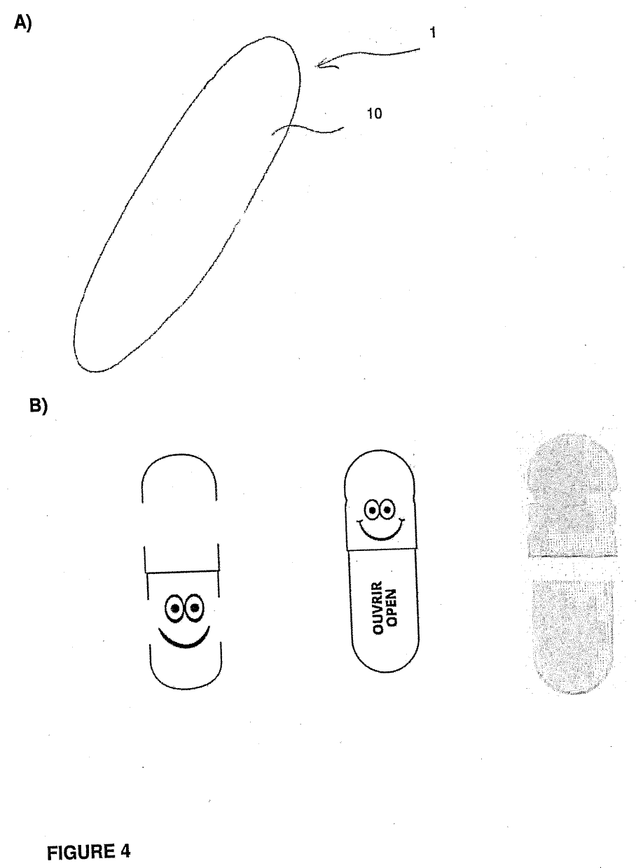

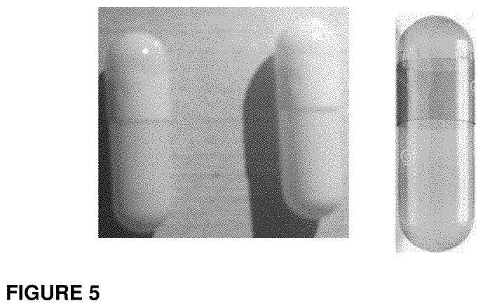

Referring to FIGS. 3 and 4A, in order to offer a portioned 100% stevia extract, pure extract of stevia 10 is filled in capsules 1, using a specific filling equipment. The trials were first performed at 6 mg and then at 18 mg. The performance showed a standard deviation (SD) of ±0.1 mg (for the target of 6 mg) and ±0.33 mg (for the target of 18 mg). This performance is acceptable even when compared to standards in the pharmaceutical industry (Tables 1-3 below). This allows for the possibility of offering to consumers, a portioned 100% stevia extract. The product is presented in capsules (FIGS. 3-5), and the content 10 of a capsule 1 yields a sweetness equivalent to the sweetness of a sugar cube or tablespoon of sugar. The capsule used is designed to be easily and safely opened for sprinkling of stevia extract on to food or beverage.

TABLE 1
Weight trials (6 mg)

| | | | | |
|---|---|---|---|---|
| Target | 6 | 6 | 6 | 6 |
| Max. | 5.93 | 5.85 | 6.38 | 6.13 |
| Min. | 5.4 | 5.53 | 5.87 | 5.7 |
| Avg. | 5.75 | 5.68 | 6.06 | 5.79 |
| Diff. | 0.53 | 0.32 | 0.51 | 0.43 |
| SD | 0.100 | 0.088 | 0.128 | 0.079 |
| Results | =5.75 ± 0.1 | =5.68 ± 0.1 | =6.06 ± 0.1 | =5.79 ± 0.1 |

Total Weight = 814.68 mg

TABLE 2
Weight test stevia capsules (6 mg)

| | Weight Test Stevia capsules 6 mg | | | |
|---|---|---|---|---|
| | Weight mg | Weight mg | Weight mg | Weight mg |
| | Run 1 | Run 2 | Run 3 | Run 4 |
| 1 | 5.9 | 5.58 | 6.14 | 5.88 |
| 2 | 5.65 | 5.54 | 6.33 | 5.77 |
| 3 | 5.79 | 5.64 | 6.24 | 5.72 |
| 4 | 5.72 | 5.76 | 6.04 | 5.8 |
| 5 | 5.74 | 5.77 | 6.08 | 5.71 |
| 6 | 5.71 | 5.57 | 6.02 | 5.91 |
| 7 | 5.77 | 5.64 | 5.95 | 5.72 |
| 8 | 5.86 | 5.61 | 6.29 | 5.73 |
| 9 | 5.93 | 5.7 | 5.87 | 5.85 |
| 10 | 5.4 | 5.64 | 6.26 | 5.74 |
| 11 | 5.82 | 5.77 | 6.21 | 5.88 |
| 12 | 5.8 | 5.56 | 6.01 | 5.73 |
| 13 | 5.71 | 5.82 | 5.94 | 5.76 |
| 14 | 5.78 | 5.72 | 6.14 | 5.75 |
| 15 | 5.77 | 5.72 | 6.21 | 5.73 |
| 16 | 5.8 | 5.85 | 5.97 | 5.74 |
| 17 | 5.79 | 5.79 | 6.06 | 5.82 |
| 18 | 5.72 | 5.78 | 6.07 | 5.83 |
| 19 | 5.85 | 5.6 | 6.28 | 5.79 |
| 20 | 5.85 | 5.76 | 6.13 | 5.82 |
| 21 | 5.64 | 5.67 | 5.99 | 5.8 |
| 22 | 5.76 | 5.56 | 5.97 | 5.74 |
| 23 | 5.62 | 5.82 | 5.97 | 5.81 |
| 24 | 5.72 | 5.71 | 5.99 | 5.76 |
| 25 | 5.74 | 5.55 | 5.92 | 5.73 |
| 26 | 5.74 | 5.69 | 5.91 | 5.77 |
| 27 | 5.81 | 5.53 | 6.07 | 5.82 |
| 28 | 5.76 | 5.71 | 5.89 | 6.13 |
| 29 | 5.58 | 5.66 | 5.97 | 5.7 |
| 30 | 5.74 | 5.65 | 5.9 | 5.71 |
| 31 | 5.72 | 5.66 | 5.95 | 5.78 |
| 32 | 5.66 | 5.67 | 6.05 | 5.78 |
| 33 | 5.86 | 5.74 | 6.03 | 5.79 |
| 34 | 5.73 | 5.65 | 6.03 | 5.75 |
| 35 | 5.86 | 5.74 | 6.06 | 5.77 |

TABLE 3
Weight trials (18 mg)

| | Track | Track | Track | Track | Track |
|---|---|---|---|---|---|
| | 1 | 2 | 3 | 4 | 5 |
| | Target 18 mg (Maximum achievable | | | | |
| | with the existing cylinder) | | | | |
| | 18 | 18.32 | 18.55 | 18.75 | 18.6 |
| | 18.32 | 18.55 | 18.8 | 18.7 | 18.72 |
| | 17.72 | 18.05 | 18.63 | 18.28 | 19.01 |
| | 18.02 | 18.15 | 18.6 | 18.37 | 18.75 |
| Average (per track) | 18.02 | 18.27 | 18.65 | 18.53 | 18.77 |
| Overall average | 18.44 | | | | |
| Standard Dev. (per Track) | 0.25 | 0.22 | 0.11 | 0.23 | 0.17 |

| | |
|---|---|
| Overall Standard Dev. | 0.33 |

The weights are from the second run with the new filters
The capsules were produced at 120 cpm machine speed (=36,000 capsules per minute)
Samples were taken after each 2 minutes during the run

Table 4 and Table 5 below outline the composition of the stevia product according to the invention (ReelPur™) and a few portioned stevia products currently available on the market. As can be seen, none of the products currently available on the market contains stevia extract alone.

TABLE 4
Comparing a few stevia products

| | ReelPur ™ | | | | |
|---|---|---|---|---|---|
| | (product | | | | |
| | according to | | | Stevia in | Walt |
| Brand | the invention) | PureVia ™ | Truvia ™ | the Raw ™ | Mart ™ |
| Product | ReelPur | PureVia | Truvia | In The Raw | Great Value |
| | Stevia | | | | Stevia |
| Ingredients | Stevia leaf | Dextrose, | Erythritol, | Dextrose, | Erythritol, |
| list | extract (100%) | Steviol | stevia leaf | Stevia | Stevia |
| | | glycosides (28 | extract, natural | Glycosides | extract leaf, |
| | | mg), cellulose | flavors | | Flavour |
| | | powder, Flavors | | | |
| High intensity | Stevia | Stevia | Stevia | Stevia | Stevia |
| ingredient | | | | | |
| Base | Stevia | Corn dextrose | Corn erythritol | Corn Dextrose | Corn |
| ingredient | | | | | Dextrose |
| Serving size | 16.5 | 1000 | 3000 | 1000 | 2000 |
| (mg) | | | | | |
| % Pur stevia in | 100% | 2.8% | <3% | <3% | <2% |
| product | | | | | |
| Other added | 0 | 97.2% (59 | >95% (180 | >97% (58 | >98% (120 |
| ingredients | | times) | times) | times) | times) |
| (ReelPur cap. | | | | | |
| weight equivalent) | | | | | |

| | Sugar | President | Skinny |
|---|---|---|---|
| Brand | Lantic ™ | Choice ™ | Girl ™ |
| Product | Lantic Stevia | PC Stevia | Skinnygirl |
| | | | Organic Stevia |
| Ingredients | Erythritol, | Erythritol, natural | Organic |
| list | Stevia leaf | stevia extract, | dextrose, |
| | extract (Natural | Flavour | Organic stevia |
| | polyol), Natural | | |
| | flavours | | |
| High intensity | Stevia | Stevia | Stevia |
| ingredient | | | |
| Base | Corn Dextrose | Corn Dextrose | Corn Dextrose |
| ingredient | | | |
| Serving size | 1800 | 2000 | 1000 |
| (mg) | | | |
| % Pur stevia in | <1% | <2% | <2% |
| product | | | |
| Other added | >99% (120 | >98% (120 | >98% (59 |
| ingredients | times) | times) | times) |
| (ReelPur cap. | | | |
| weight equivalent) | | | |

TABLE 5
Comparing a few stevia products

| | ReelPur ™ | | | | |
|---|---|---|---|---|---|
| | (product | | | | |
| | according to | | | | |
| Brand | the invention) | Exact ™ | Sugar Twin ™ | Greeniche ™ | Weider ™ |
| Product | ReelPur | Exact | Sugar Twin | Stevia The | Stevia |
| | Stevia | Stevia | Stevia | Gold | Sweet |
| Ingredients | Stevia leaf | Maltodextrin, | Erythritol, 14 | Erythritol, | Maltodextrine, |
| list | extract (100%) | Stevia extract | mg Stevia | Stevia extract | Stevia, Talin |
| | | | extract per ½ | (99.8%) | RMD90, |
| | | | packet (1 g), | rebaudioside | Vitamin C |
| | | | Flavours | A), Silicon | |
| | | | | Dioxide | |
| High intensity | Stevia | Stevia | Stevia | Stevia | Stevia |
| ingredient | | | | | |
| Base | Stevia | Maltodextrine | Corn | Corn | Maltodextrine |
| ingredient | | | Erythritol | Erythritol | |
| Serving size | 16.5 | 1000 | 2000 | 1500 | 600 |
| (mg) | | | | | |
| % Pure stevia in | 100% | 3.3% | <2% | <3% | <4.75% |
| Product | | | | | |
| Other added | 0 | >96.7% (58.5 | >98% (59.75 | >97% (89 | >95% (35 |
| ingredients | | times) | times) | times) | times) |
| (ReelPur cap. | | | | | |
| weight equivalent) | | | | | |

| Brand | Equate ™ | Sweet Leaf ™ | Whole Earth ™ |
|---|---|---|---|
| Product | Equate | Organic | Starbucks |
| | Stevia | Stevia | WHOLE |
| | | | EARTH |
| Ingredients | Maltodextrine, | Inulin, Organic | Erythritol, |
| list | Steviol | stevia extract | Fructose, Chicory |
| | glycosides | | Root Fiber, |
| | | | Stevia Leaf |
| | | | Extract, Monk |
| | | | Fruit Extract |
| High intensity | Stevia | Stevia | Stevia, Monk |
| ingredient | | | fruit |
| Base | Maltodextrine | Inulin | Corn |
| ingredient | | | Erythritol |
| Serving size | 1000 | 1000 | 2000 |
| (mg) | | | |
| % Pure stevia in | <3% | <3% | <2% |
| Product | | | |
| Other added | >97% (59 | >97% (59 | >98% (59.75 |
| ingredients | times) | times) | times) |
| (ReelPur cap. | | | |
| weight equivalent) | | | |

The capsule is adapted to be operated manually by a user, such as to release the stevia extract, into a cup for example.

As will be understood by a skilled person, a capsule may be presented such that the sweetness of its content is equivalent to the sweetness of, for example, half a sugar cube or table spoon, as desired.

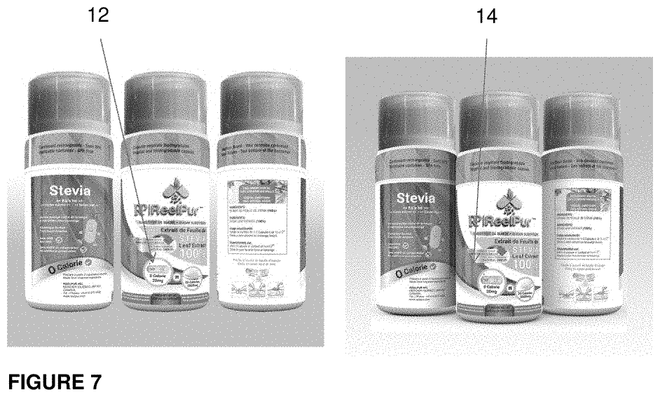

Also as will be understood by a skilled person, a plurality of capsules according to the invention may be offered in a container (FIG. 7). Such container may be for example a capsule distributor. A user may operate the container with both hands, or with a single hand. In the specific embodiment illustrated in FIG. 7, the containers on the left comprise white capsules (12) and the containers on the right comprise green capsules (14).

Indeed in embodiments of the invention, the capsule may have a color selected from the group consisting of: white, green, brown, colourless, yellow, red, blue, black, ivory, orange, grey, pink, pearly blue, and combinations thereof. Optionally, the capsule is opaque or transparent. In further embodiments, a sign printed may be printed on an external surface of the capsule (FIG. 4B). Optionally the sign is selected from the group consisting of: image of a human face, image of an object, group of letters, words, and combinations thereof.

As indicated above, a capsule 1 (FIGS. 3 and 4A) is provided. The capsule is filled with pure (about 100%) stevia extract 10. An amount of the stevia extract in the capsule is: between about 6 to 8 mg, between about 8 to 10 mg, between about 10 to 12 mg, between about 12 to 14 mg, between about 13 to 15 mg, between about 13.5 to 16.5 mg, preferably between about 14 to 17 mg, preferably between about 15 to 19 mg, preferably between about 16 to 20 mg, preferably between about 17 to 21 mg, preferably between about 18 to 22 mg, preferably between about 19 to 23 mg, preferably between about 20 to 24 mg, preferably between about 21 to 25 mg, preferably between about 22 to 26 mg, or between about 6.5 to 8.5 mg, etc. The invention also allows to fill 100% pure stevia extract for an equivalent sweetness of sugar/saccharose from one cube (or table spoon) to multiple sugar cubes (2, 3, 4, 5 . . . 10. etc. as desired) in a capsule for various food applications, such as for example bakery at home.

In embodiments of the invention, the amount of the stevia extract in the capsule is between about 13.5 to 16.5 mg or multiple of these weights (example between 27 to 33 mg or 40.5 to 49.5 mg, etc).

In embodiments of the invention, the amount of the stevia extract in the capsule is between about a multiple of the amount 13.5 to 16.5 mg, for example 27 to 33 mg, 40.5 to 49.5 mg, 54 to 66 mg etc as desired.

In embodiments of the invention, the amount of the stevia extract in the capsule is between about 6.5 to 8.5 mg.

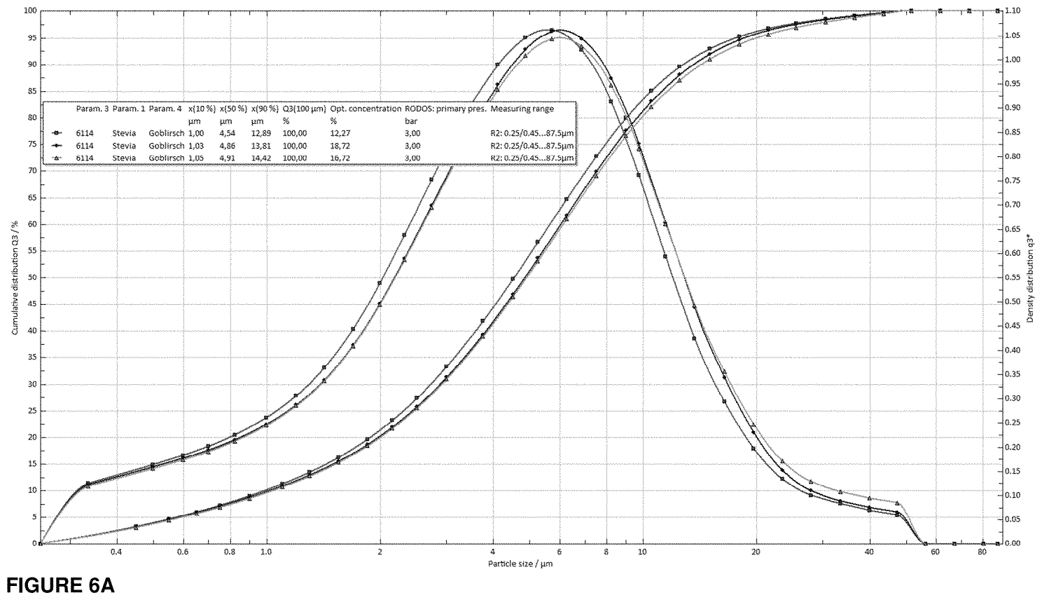

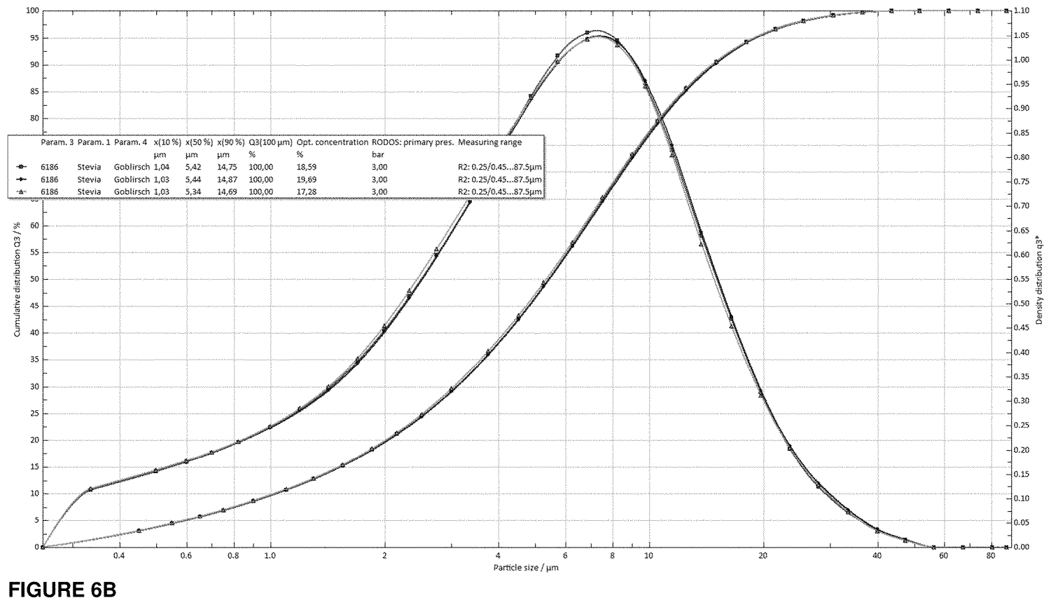

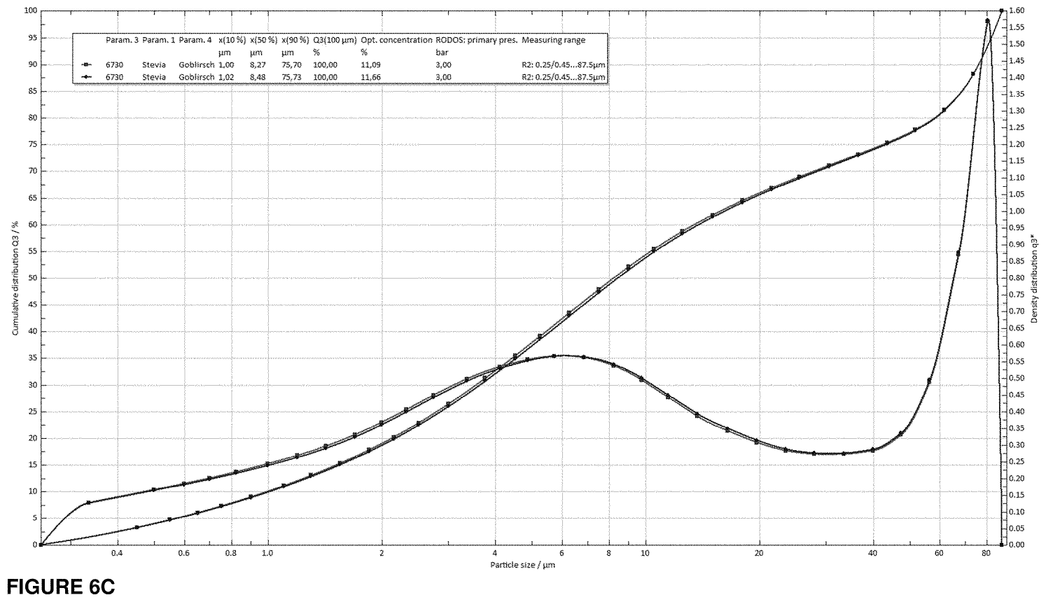

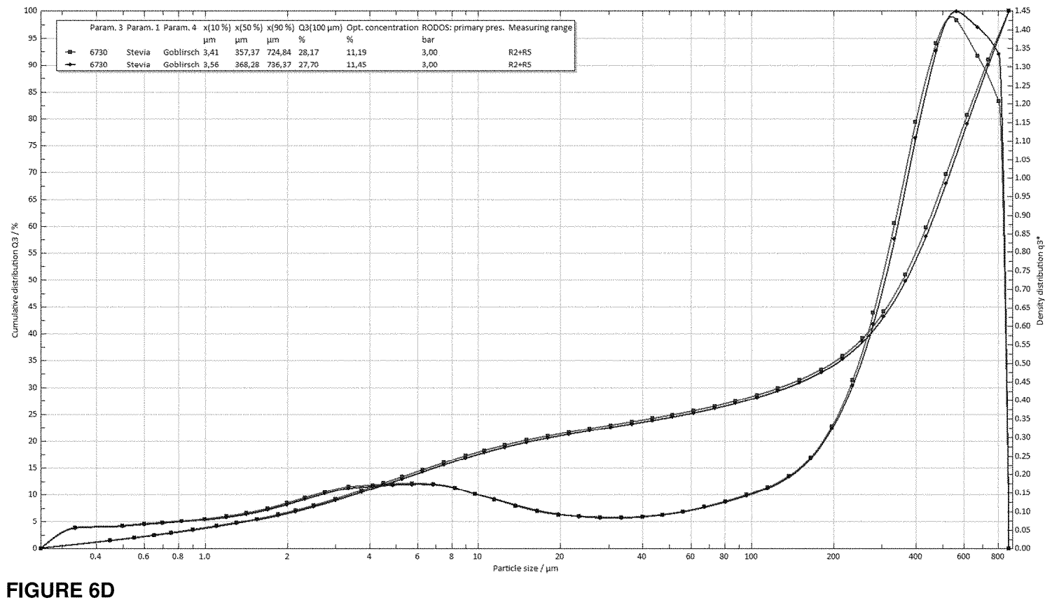

In embodiments of the invention, the stevia extract is in powder form (FIG. 3). The particles of the powder have specific sizes. The particles sizes of the stevia extract in powder form are illustrated in FIGS. 6A-6D and Table 6 below. As will be understood by a skilled person, the stevia extract may also be in a form which is liquid, granular, pieces of dry leaf, or a combination thereof.

TABLE 6
Particles sizes of the stevia extract

| Product | | ×10 [μm] | ×50 [μm] | ×90 [μm] |
|---|---|---|---|---|
| 6114 Stevia | Mean | 1.03 | 4.77 | 13.71 |
| | SD | 0.03 | 0.20 | 0.77 |
| 6186 Stevia | Mean | 1.03 | 5.40 | 14.77 |
| | SD | 0.01 | 0.05 | 0.09 |
| 6730 Stevia | Mean | 3.49 | 362.83 | 730.61 |
| | SD | 0.11 | 7.71 | 8.15 |

In embodiments of the invention, the capsule is made of a material which is: hydroxypropyl methyl cellulose (HPMC) hydroxymethyl cellulose (HMC), gelatin, pullulan naturally fermented from tapioca, vegetable-based material, or a combination thereof. Optionally, the material is bio-degradable. In embodiments of the invention, the material may be soluble in aqueous medium. In other embodiments of the invention, the material may be insoluble in aqueous medium.

In embodiments of the invention, the capsule has an elongated spherical shape. A length of the capsule may be between about 7 to 100 mm and a width between about 3 to 28 mm; preferably a length between about 10 to 90 mm and a width between about 4 to 25 mm; preferably a length between about 11.1 to 88.5 mm and a width between about 4.91 to 23.4 mm. Table 7 below outlines the various dimensions and sizes of the capsule according to the invention.

TABLE 7
Size, shape, and other physical attributes
of generic tablets and capsules

| | Volume | Closed length | External diameter |
|---|---|---|---|
| Size | (mL) | (mm) | (mm) |
| 5 | 0.13 | 11.1 | 4.91 |
| 4 | 0.21 | 14.3 | 5.31 |
| 3 | 0.30 | 15.9 | 5.82 |
| 2 | 0.37 | 18 | 6.35 |
| 1 | 0.50 | 19.4 | 6.91 |
| 0 | 0.68 | 21.7 | 7.65 |
| 0E | 0.7 | 23.1 | 7.65 |
| 00 | 0.95 | 23.3 | 8.53 |
| 000 | 1.37 | 26.14 | 9.91 |
| 13 | 3.2 | 30 | 15.3 |
| 12 | 5 | 40.5 | 15.3 |
| 12el | 7.5 | 57 | 15.5 |
| 11 | 10 | 47.5 | 20.9 |
| 10 | 18 | 64 | 23.4 |
| 7 | 24 | 78 | 23.4 |
| Su07 | 28 | 88.5 | 23.4 |

As will be understood by a skilled person, pure (about 100%) stevia extract according to the invention may be presented in a container in bulk form, and a user may use a device, such as a spoon or the like, to retrieve a desired amount of the extract.

As will be understood by a skilled person, the invention thus provides a method of making readily available to consumers a stevia extract that is about 100% pure, preferably in portioned form.

As will be understood by a skilled person, the capsule according to the invention may further comprise at least one other product, for example having a nutritional value to consumers. Such other product may be for example a nutritional supplement, a vitamin, a flavor. In this embodiment, the amount of the stevia in the product is more than about 60%.

As will be understood by a skilled person, the presentation and packaging according to the invention may be applied to other sweeteners presenting challenges similar to stevia extract. Such sweeteners may include, but are not limited to, extracts of other plants and artificially prepared products.

The scope of the claims should not be limited by the preferred embodiments set forth in the examples, but should be given the broadest interpretation consistent with the description as a whole.

The present description refers to a number of documents, the content of which is herein incorporated by reference in their entirety.

1.-2. (canceled)

3. A capsule containing a stevia extract that is about 100% pure, wherein the content of the capsule has a sweetness which is equivalent to the sweetness of a sugar cube or table spoon.

4. A capsule containing a stevia extract that is about 100% pure, wherein the amount of the stevia extract in the capsule is: between about 6 to 8 mg, between about 8 to 10 mg, between about 10 to 12 mg, between about 12 to 14 mg, between about 13 to 15 mg, between about 13.5 to 16.5 mg, between about 14 to 17 mg, between about 15 to 19 mg, between about 16 to 20 mg, between about 17 to 21 mg, between about 18 to 22 mg, between about 19 to 23 mg, between about 20 to 24 mg, between about 21 to 25 mg, between about 22 to 26 mg, or between about 6.5 to 8.5 mg, etc.

5. A capsule according to claim 3, wherein the amount of the stevia extract in the capsule is between about 13.5 to 16.5 mg, optionally the amount of the stevia extract in the capsule is between about a multiple of the amount 13.5 to 16.5 mg, for example 27 to 33 mg, 40.5 to 49.5 mg, 54 to 66 mg, etc.

6.-7. (canceled)

8. A capsule according to claim 1, wherein the stevia extract is in a form selected from the group consisting of: powder, liquid, granular, pieces of dry leaf, and combinations thereof.

9. (canceled)

10. A capsule according to claim 3, further comprising a component selected from the group consisting of nutritional supplement, vitamins, flavours; optionally; the amount of the stevia extract in the capsule is more than about 60% by weight.

11. A capsule according to claim 3, wherein the capsule is made of a material selected from the group consisting of:
hydroxypropyl methyl cellulose (HPMC) hydroxymethyl cellulose (HMC), gelatin, pullulan naturally fermented from tapioca, vegetable-based material, and combinations thereof.

12. A capsule according to claim 3, wherein the capsule is made of a material that is bio-degradable.

13. A capsule according to claim 3, wherein the capsule is made of a material that is soluble in aqueous medium.

14. A capsule according to claim 3, wherein the capsule is made of a material that is not soluble in aqueous medium.

15. A capsule according to claim 3, wherein the capsule is adapted to be operated manually by a user, such as to release the stevia extract.

16. A capsule according to claim 3, wherein the capsule has an elongated spherical shape, and has a length between about 7 to 100 mm and a width between about 3 to 28 mm; or has a length between about 10 to 90 mm and a width between about 4 to 25 mm; or has a length between about 11.1 to 88.5 mm and a width between about 4.91 to 23.4 mm.

17. (canceled)

18. A capsule according to claim 3, having a size between about 5 to Su07.

19. A capsule according to claim 3, wherein the capsule has a color selected from the group consisting of: white, green, brown, colourless, yellow, red, blue, black, ivory, orange, grey, pink, pearly blue, and combinations thereof; optionally the capsule is opaque or transparent.

20. A capsule according to claim 3, having a sign printed on an external surface thereof; optionally the sign is selected from the group consisting of: image of a human face, image of an object, group of letters, words, and combinations thereof.

21.-26. (canceled)

27. A method of making available to consumers a stevia extract that is about 100% pure, the method comprising:
providing the stevia extract that is about 100% pure;
providing a capsule; and
filling up the capsule with the stevia extract that is about 100% pure,
wherein the content of the capsule has a sweetness which is equivalent to the sweetness of a sugar cube or table spoon;
optionally an amount of the stevia extract in the capsule is between about 6 to 8 mg, between about 8 to 10 mg, between about 10 to 12 mg, between about 12 to 14 mg, between about 13 to 15 mg, between about 13.5 to 16.5 mg, between about 14 to 17 mg, between about 15 to 19 mg, between about 16 to 20 mg, between about 17 to 21 mg, between about 18 to 22 mg, between about 19 to 23 mg, between about 20 to 24 mg, between about 21 to 25 mg, between about 22 to 26 mg, or between about 6.5 to 8.5 mg, etc.

28.-30. (canceled)

31. A method of using a stevia extract, comprising manually operating a capsule as defined in claim 3, such as to release the stevia extract for use, for example in a container (cup) containing food (in solid or liquid form).

32. A package comprising one or more capsules as defined in claim 3.

33. A container comprising a plurality of capsules as defined in claim 3, wherein the container is readily manually operable by a user, such as to release one or more capsules; optionally the user uses both hands for the operation or a single hand.

34. A container according to claim 33, which is a capsule distributor.

35. (canceled)

36. A kit comprising:
one or more containers each comprising a plurality of capsules as defined in claim 3, wherein the container is readily manually operable by a user, such as to release one or more capsules; optionally, the user uses both hands for the operation or a single hand; and
one or more packages each comprising one or more capsules as defined in claim 3,
optionally the kit comprises instructions for use.

37.-38. (canceled)
